(19) United States
(12) Patent Application Publication
(10) Pub. No.: US 2026/0261017 A1
(43) Pub. Date: Sep. 3, 2026

(54) POWER STORAGE DEVICE

(71) Applicants: TOYOTA JIDOSHA KABUSHIKI KAISHA, Toyota-shi (JP); Prime Planet Energy & Solutions, Inc., Tokyo (JP)

(72) Inventors: Yasuhiro SAKASHITA, Nisshin-shi (JP); Norihiro OSE, Nagoya-shi (JP); Masato ONO, Nisshin-shi (JP); Koichi YANASE, Nagoya-shi (JP); Takeru HARA, Toyota-shi (JP); Yuka YOKOI, Nagoya-shi (JP); Kohji UMEMURA, Ono-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/552,137

(22) Filed: Feb. 27, 2026

(30) Foreign Application Priority Data
Mar. 3, 2025 (JP) 2025-032915

(51) Int. Cl. H01M 50/538; H01M 10/0587; H01M 50/103; H01M 50/15; H01M 50/474; H01M 50/533

(52) U.S. Cl. CPC H01M 50/538; H01M 10/0587; H01M 50/103; H01M 50/15; H01M 50/474; H01M 50/533

(57) ABSTRACT

A power storage device includes an electrode assembly with a laminated sheet wound about a winding axis. The electrode assembly includes first and second winding faces disposed spaced apart in an axial direction where the winding axis extends, and a current collector tab group projecting in the axial direction from the first winding face. The power storage device further includes an insulating member disposed covering the first winding face and has a through hole, and a current collector plate disposed on the insulating member and has a through hole. The current collector plate includes a principal face on a side of the current collector plate opposite to where the insulating member is situated. The current collector tab group passes through the through holes. A distal end portion of the current collector tab group in a direction protruding from the first winding face is bent and welded to the principal face.

### CROSS-REFERENCE TO RELATED APPLICATION

This application claims priority to Japanese Patent Application No. 2025-032915 filed on March 3, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2022-44958 (JP 2022-44958 A) discloses a battery (power storage device) including an electrode assembly in which current collector tabs (current collector tab group) and a current collector terminal (current collector plate) are welded together.

### SUMMARY

When the current collector tab group and the current collector plate are welded together, foreign matter produced during the welding may become incorporated into the electrode assembly.

The present disclosure has been made taking into consideration the foregoing problem, and an object thereof is to suppress foreign matter produced during welding from becoming incorporated into the electrode assembly when welding a current collector tab group and a current collector plate.

(1) A power storage device according to an aspect of the present disclosure includes an electrode assembly in which a laminated sheet including a first electrode sheet, a separator, and a second electrode sheet, is wound about a winding axis. The electrode assembly includes a first winding face and a second winding face that are disposed spaced apart in an axial direction in which the winding axis extends, and a current collector tab group protruding from the first winding face in the axial direction. The power storage device further includes an insulating member disposed so as to cover the first winding face, with a first through hole opened in the insulating member, and a current collector plate disposed on the insulating member, with a second through hole opened in the current collector plate. The current collector plate includes a principal face situated on a side of the current collector plate opposite to a side on which the insulating member is situated. The current collector tab group passes through the first through hole and the second through hole. A distal end portion of the current collector tab group in a direction protruding from the first winding face is bent and welded to the principal face.

(2) In the power storage device according to (1) above, the current collector tab group includes a first current collector tab group and a second current collector tab group. The electrode assembly includes a peripheral face connecting the first winding face and the second winding face. The peripheral face includes a first flat face, a second flat face, and a first curved face and a second curved face connecting the first flat face and the second flat face. The first flat face and the second flat face are arrayed in a first array direction. The first curved face and the second curved face are arrayed in a second array direction intersecting the first array direction. The first current collector tab group and the second current collector tab group are disposed spaced apart in the first array direction and the second array direction.

(3) The power storage device according to (1) or (2) above further includes a case that accommodates the electrode assembly. The case includes a case body having an opening, and a lid including a lid body that is fashioned to cover the opening. The case body includes a bottom wall and a peripheral wall erected from the bottom wall. The power storage device further includes a smoke discharge valve provided in the bottom wall.

(4) The power storage device according to (1) or (2) above further includes a case that accommodates the electrode assembly, and an insulating plate. The case includes a case body having an opening, and a lid including a lid body that is fashioned to cover the opening. The insulating plate is disposed between the electrode assembly and the lid body so as to cover the insulating member and the current collector plate.

(5) In the power storage device according to (4) above, the case body includes a bottom wall and a peripheral wall erected from the bottom wall. The power storage device further includes a smoke discharge valve provided in the bottom wall.

According to the present disclosure, when welding a current collector tab group and a current collector plate, foreign matter produced during welding can be suppressed from becoming incorporated into an electrode assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a power storage device according to an embodiment;

FIG. 2 is an exploded perspective view of the power storage device 1 illustrated in FIG. 1;

FIG. 3 is a perspective view of an electrode assembly 20 illustrated in FIG. 2;

FIG. 4 is a cross-sectional view taken along line IV-IV in FIG. 1;

FIG. 5 is a cross-sectional view taken along line V-V in FIG. 1; and

FIG. 6 is an enlarged cross-sectional view of region VI in FIG. 4.

### DETAILED DESCRIPTION OF EMBODIMENTS

An embodiment of the present disclosure will be described in detail below with reference to the drawings. Note that the same or corresponding portions are denoted by the same signs throughout the drawings, and description thereof will not be repeated.

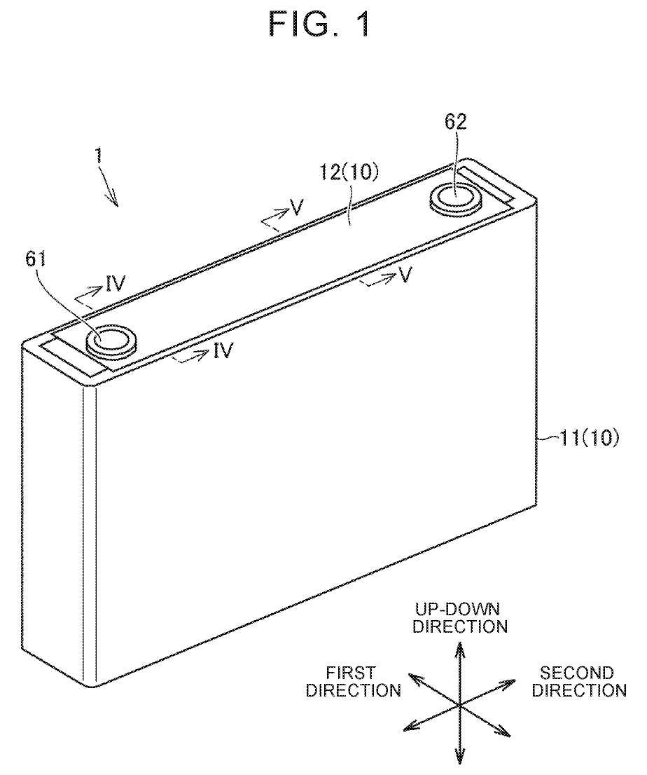

FIG. 1 is a perspective view illustrating a power storage device according to the present embodiment. The power storage device 1 is a storage battery (secondary battery) such as a lithium-ion battery, a nickel metal hydride battery, or the like. The power storage device 1 is installed in an electrified vehicle, for example, and stores electric power for the electrified vehicle to travel.

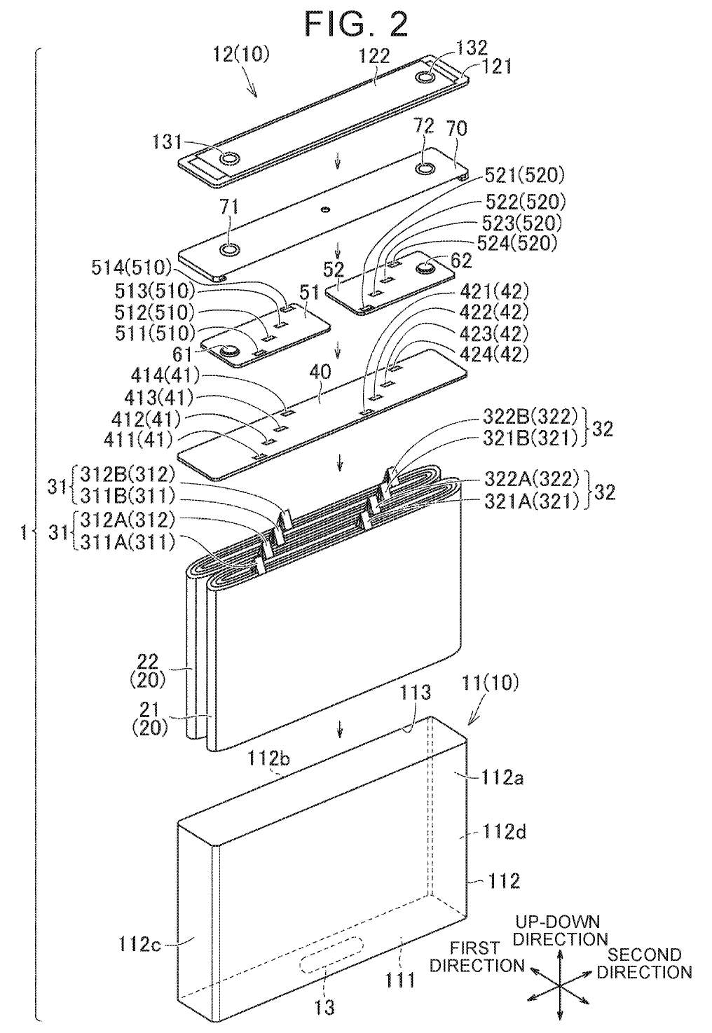

FIG. 2 is an exploded perspective view of the power storage device 1 illustrated in FIG. 1. The power storage device 1 includes a case 10, a smoke discharge valve 13, two electrode assemblies 20, an insulating member 40, a current collector plate 51, a current collector plate 52, a first external terminal 61, a second external terminal 62, and an insulating plate 70.

The case 10 has electrical conductivity. Portions of the case 10 that have electrical conductivity are made of a metal such as, for example, aluminum or the like. The case 10 accommodates two electrode assemblies 20 and an electrolytic solution (omitted from illustration).

The case 10 includes a case body 11 and a lid 12. The case body 11 has an opening 113. Specifically, the case body 11 includes a bottom wall 111 and a peripheral wall 112 erected from the bottom wall 111.

The peripheral wall 112 includes a side wall 112a, a side wall 112b, a side wall 112c, and a side wall 112d. The side wall 112a and the side wall 112b are disposed spaced apart in a first direction. The side wall 112a and the side wall 112b are formed extending in a second direction.

The side wall 112c and the side wall 112d are disposed spaced apart in the second direction. The side wall 112c and the side wall 112d connect the side wall 112a and the side wall 112b. Specifically, the side wall 112c connects one end of the side wall 112a to one end of the side wall 112b. The side wall 112d connects the other end of the side wall 112a to the other end of the side wall 112b.

The bottom wall 111 and the lid 12 are disposed spaced apart in an up-down direction (vertical direction). The first direction, the second direction, and the up-down direction are perpendicular to one another. Note that the first direction, the second direction, and the up-down direction only need to intersect each other, and do not have to be orthogonal to each other.

The lid 12 includes a lid body 121 and an insulating cover 122. The lid body 121 is formed so as to cover the opening 113. For example, the lid body 121 is joined to the peripheral wall 112 by welding or the like, so as to close the opening 113. The insulating cover 122 is made of a resin composition having electrical insulating properties. The lid 12 has holes 131, 132 formed therein, passing through the lid body 121 and the insulating cover 122.

The smoke discharge valve 13 is provided in the bottom wall 111. The smoke discharge valve 13 is configured to open when internal pressure of the case 10 is a standard value or higher. When the smoke discharge valve 13 opens, gas inside of the case 10 is discharged to outside of the case 10. Note that the smoke discharge valve 13 may be made up of a check valve.

Two electrode assemblies 20 include an electrode assembly 21 and an electrode assembly 22. Note that it is sufficient for the number of electrode assemblies 20 to be one or more. The electrode assembly 21 and the electrode assembly 22 have the same configuration. In the present disclosure, when there is no need to distinguish between the electrode assembly 21 and the electrode assembly 22, they will simply be referred to as "electrode assembly 20". The electrode assembly 20 includes a current collector tab group 31 and a current collector tab group 32.

The current collector tab group 31 is a cathode current collector tab group. The current collector tab group 31 includes a current collector tab group 311 and a current collector tab group 312. The current collector tab group 311 corresponds to "first current collector tab group" according to the present disclosure, and the current collector tab group 312 corresponds to "second current collector tab group" according to the present disclosure.

The current collector tab group 32 is an anode current collector tab group. The current collector tab group 32 includes a current collector tab group 321 and a current collector tab group 322. The current collector tab group 321 corresponds to "first current collector tab group" according to the present disclosure, and the current collector tab group 322 corresponds to "second current collector tab group" according to the present disclosure.

A current collector tab group 311A corresponds to the current collector tab group 311 of the electrode assembly 21, and a current collector tab group 312A corresponds to the current collector tab group 312 of the electrode assembly 21. A current collector tab group 321A corresponds to the current collector tab group 321 of the electrode assembly 21, and a current collector tab group 322A corresponds to the current collector tab group 322 of the electrode assembly 21. A current collector tab group 311B corresponds to the current collector tab group 311 of the electrode assembly 22, and a current collector tab group 312B corresponds to the current collector tab group 312 of the electrode assembly 22. A current collector tab group 321B corresponds to the current collector tab group 321 of the electrode assembly 22, and a current collector tab group 322B corresponds to the current collector tab group 322 of the electrode assembly 22.

Note that it is sufficient for the number of the cathode current collector tab groups to be one or more. Also, it is sufficient for the number of the anode current collector tab groups to be one or more.

The insulating member 40 is made of a resin composition having electrical insulating properties. The insulating member 40 has a plurality of through holes 41 passing through the insulating member 40, and a plurality of through holes 42 passing through the insulating member 40, formed therein. The through holes 41 include a through hole 411, a through hole 412, a through hole 413, and a through hole 414. The through holes 42 include a through hole 421, a through hole 422, a through hole 423, and a through hole 424. Each of the through hole 411, the through hole 412, the through hole 413, the through hole 414, the through hole 421, the through hole 422, the through hole 423, and the through hole 424 corresponds to "first through hole" according to the present disclosure.

The current collector plate 51 is a cathode current collector plate. The current collector plate 51 has a plurality of through holes 510, passing through the current collector plate 51, formed therein. The through holes 510 include a through hole 511, a through hole 512, a through hole 513, and a through hole 514. The through-holes 510 are formed at positions aligned with the through holes 41 in the up-down direction.

The current collector plate 52 is an anode current collector plate. The current collector plate 52 has a plurality of through holes 520, passing through the current collector plate 52, formed therein. The through holes 520 include a through hole 521, a through hole 522, a through hole 523, and a through hole 524. The through-holes 520 are formed at positions aligned with the through holes 42 in the up-down direction. Each of the through hole 511, the through hole 512, the through hole 513, the through hole 514, the through hole 521, the through hole 522, the through hole 523, and the through hole 524 corresponds to "second through hole" according to the present disclosure.

The current collector tab group 31 passes through the through hole 41 and the through hole 510. Specifically, the current collector tab group 311A passes through the through hole 411 and the through hole 511. The current collector tab group 312A passes through the through hole 412 and the through hole 512. The current collector tab group 311B passes through the through hole 413 and the through hole 513. The current collector tab group 312B passes through the through hole 414 and the through hole 514. The current collector tab group 31 is electrically connected to the first external terminal 61 by the current collector plate 51.

The current collector tab group 32 passes through the through hole 42 and the through hole 520. Specifically, the current collector tab group 321A passes through the through hole 421 and the through hole 521. The current collector tab group 322A passes through the through hole 422 and the through hole 522. The current collector tab group 321B passes through the through hole 423 and the through hole 523. The current collector tab group 322B passes through the through hole 424 and the through hole 524. The current collector tab group 32 is electrically connected to the second external terminal 62 by the current collector plate 52.

The first external terminal 61 is a cathode terminal. The first external terminal 61 is provided on the current collector plate 51. The second external terminal 62 is an anode terminal. The second external terminal 62 is provided on the current collector plate 52.

The insulating plate 70 is made of a resin composition having electrical insulating properties. The insulating plate 70 has through holes 71, 72, passing through the insulating plate 70, formed therein. The first external terminal 61 is exposed to the outside of the case 10 through the hole 71 and the hole 131. The second external terminal 62 is exposed to the outside of the case 10 through the hole 72 and the hole 132.

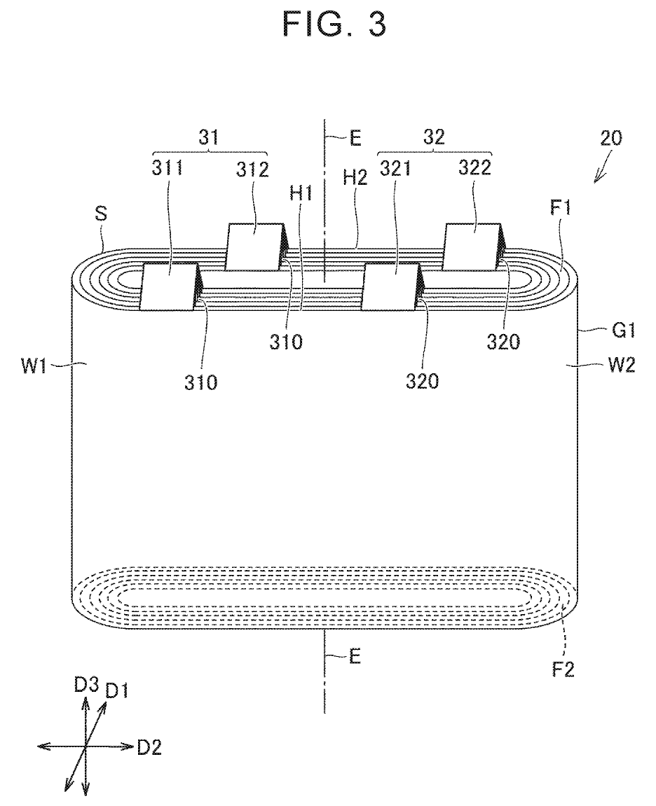

FIG. 3 is a perspective view of the electrode assembly 20 illustrated in FIG. 2. The electrode assembly 20 is a wound electrode assembly in which a laminated sheet S is wound about a winding axis E. The electrode assembly 20 includes a first winding face F1, a second winding face F2, the current collector tab group 31, and the current collector tab group 32. The first winding face F1 and the second winding face F2 are disposed spaced apart in an axial direction D3 in which the winding axis E extends. The axial direction D3 is substantially parallel to the up-down direction in FIG. 2.

The laminated sheet S has the current collector tab group 31 and the current collector tab group 32 welded thereto. As described above, the current collector tab group 31 includes the current collector tab group 311 and the current collector tab group 312, and the current collector tab group 32 includes the current collector tab group 321 and the current collector tab group 322. Each of the current collector tab group 311 and the current collector tab group 312 includes a plurality of current collector tabs 310. Each of the current collector tab group 321 and the current collector tab group 322 includes a plurality of current collector tabs 320. The current collector tab group 31 and the current collector tab group 32 protrude from the first winding face F1 in the axial direction D3.

The electrode assembly 20 includes a peripheral face G1 connecting the first winding face F1 and the second winding face F2. The peripheral face G1 includes a first flat face H1, a second flat face H2, and a first curved face W1 and a second curved face W2 connecting the first flat face H1 and the second flat face H2. The first flat face H1 and the second flat face H2 are arrayed in a first array direction D1. The first curved face W1 and the second curved face W2 are arrayed in a second array direction D2 that intersects the first array direction D1. More specifically, the first flat face H1 and the second flat face H2 are disposed spaced apart in the first array direction D1. The first flat face H1 and the second flat face H2 are formed extending in the second array direction D2. The first curved face W1 and the second curved face W2 are disposed spaced apart in the second array direction D2. The first curved face W1 connects one end of the first flat face H1 and one end of the second flat face H2. The second curved face W2 connects the other end of the first flat face H1 and the other end of the second flat face H2.

The first array direction D1 is substantially parallel to the first direction in FIG. 2. Also, the second array direction D2 is substantially parallel to the second direction in FIG. 2. The first array direction D1, the second array direction D2, and the axial direction D3 are perpendicular to one another. Note that the first array direction D1, the second array direction D2, and the axial direction D3 only need to intersect with each other, and do not have to be perpendicular to each other.

The current collector tab group 31 and the current collector tab group 32 are disposed spaced apart in the second array direction D2. The current collector tab group 311 and the current collector tab group 312 are disposed spaced apart in the first array direction D1 and the second array direction D2. The current collector tab group 321 and the current collector tab group 322 are disposed spaced apart in the first array direction D1 and the second array direction D2.

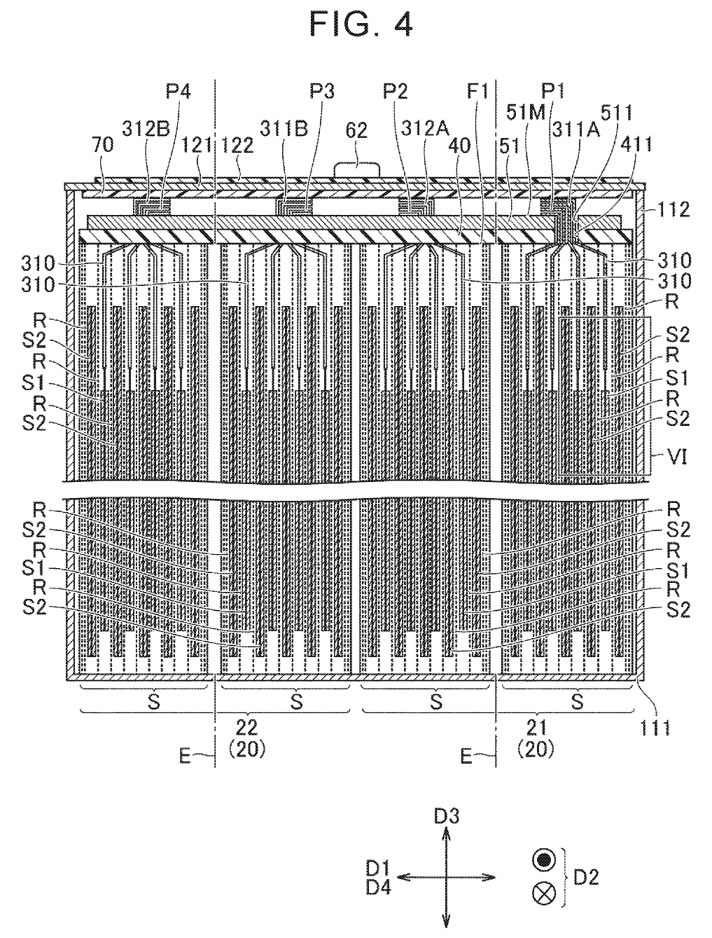

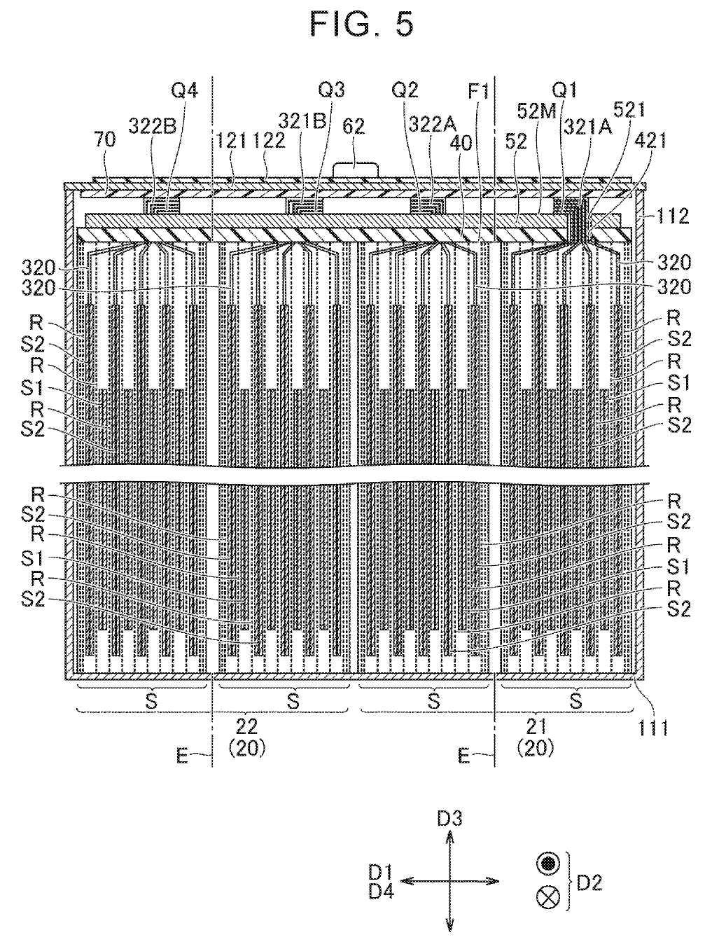

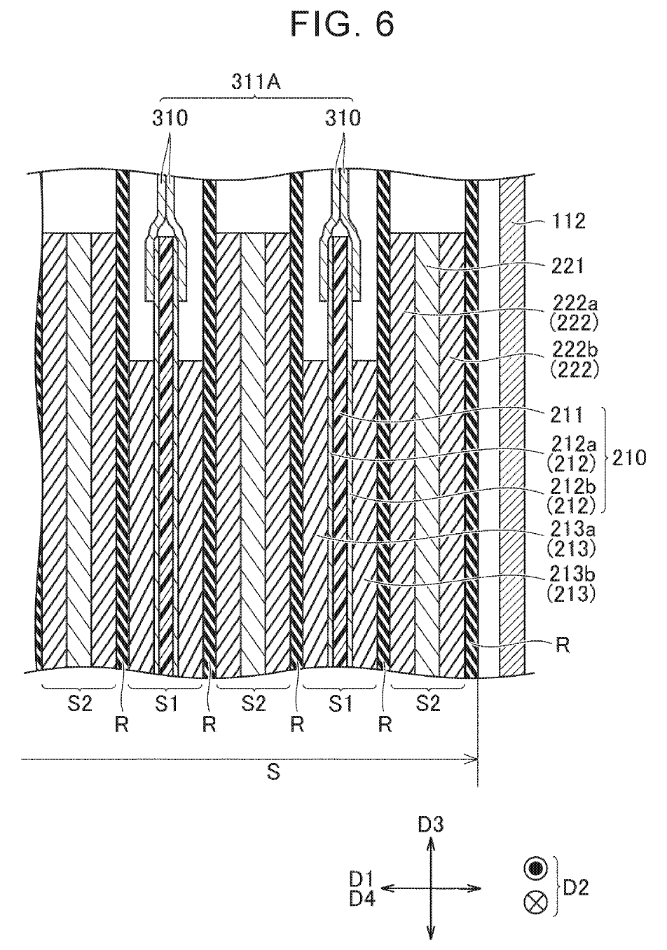

FIG. 4 is a cross-sectional view taken along line IV-IV in FIG. 1. FIG. 5 is a cross-sectional view taken along line V-V in FIG. 1. FIG. 6 is an enlarged cross-sectional view of region VI in FIG. 4. Referring to FIG. 4, each of laminate sheets S includes a first electrode sheet S1, a separator R, and a second electrode sheet S2. The first electrode sheet S1, the separator R, and the second electrode sheet S2 are laminated in a laminating direction D4 and are wound about the winding axis E. In the cross-sectional view taken along line IV-IV in FIG. 1 and the cross-sectional view taken along line V-V in FIG. 1 (i.e., FIGS. 4 to 6), the laminating direction D4 in which the first electrode sheet S1, the separator R, and the second electrode sheet S2 are laminated agrees with the first array direction D1.

Referring to FIG. 6, the first electrode sheet S1 is a cathode. The first electrode sheet S1 includes a current collector layer 210 and two active material layers 213. The current collector layer 210 includes an insulating film 211 and two conductive films 212.

The insulating film 211 is made of a resin composition that has electrical insulating properties. Each of the two conductive films 212 is made of a metal layer. Each of the conductive films 212 is made of a metal containing aluminum. Accordingly, the current collector layer 210 can be suitably used as a cathode current collector. The two conductive films 212 include a conductive film 212a and a conductive film 212b. The conductive film 212a is provided on one face of the insulating film 211 in the laminating direction D4, and the conductive film 212b is provided on the other face of the insulating film 211 in the laminating direction D4.

The current collector layer 210 includes a region in which the active material layer 213 is laminated and a region in which the active material layer 213 is not laminated.

The two active material layers 213 include an active material layer 213a and an active material layer 213b. The active material layer 213a is provided on a face of the conductive film 212a that is situated on an opposite side from the side of the conductive film 212a on which the insulating film 211 is situated. The active material layer 213b is provided on a face of the conductive film 212b that is situated on an opposite side from the side of the conductive film 212b on which the insulating film 211 is situated. A current collector tab 310 is welded to a distal end portion in the axial direction D3 of the current collector layer 210, in the region in which the active material layer 213 is not laminated.

The second electrode sheet S2 is an anode. The second electrode sheet S2 includes a current collector layer 221 and two active material layers 222. The current collector layer 221 is a conductive film made of a metal containing copper. Accordingly, the current collector layer 221 can be suitably used as an anode current collector.

The two active material layers 222 include an active material layer 222a and an active material layer 222b. The active material layer 222a is provided on one face of the current collector layer 221 in the laminating direction D4, and the active material layer 222b is provided on the other face of the current collector layer 221 in the laminating direction D4.

The separator R is provided between the first electrode sheet S1 and the second electrode sheet S2. The separator R separates the first electrode sheet S1 from the second electrode sheet S2 while allowing ions to travel between the first electrode sheet S1 and the second electrode sheet S2. The ions are, for example, lithium ions. The separator R has electrical insulating properties.

Note that the electrode assembly 20 may be a laminated electrode assembly in which the first electrode sheet S1, the separator R, and the second electrode sheet S2 are laminated.

With reference to FIGS. 4 and 5, the insulating member 40 is disposed so as to cover the first winding face F1. The current collector plate 51 and the current collector plate 52 are disposed on the insulating member 40. That is to say, the insulating member 40 is disposed between the current collector plate 51 and the electrode assembly 20, and between the current collector plate 52 and the electrode assembly 20. The insulating plate 70 is disposed between the electrode assembly 20 and the lid body 121 so as to cover the insulating member 40, the current collector plate 51, and the current collector plate 52.

Referring to FIG. 4, the current collector plate 51 includes a principal face 51M situated on the side of the current collector plate 51 opposite to the side on which the insulating member 40 is situated. The current collector tab group 311A and the current collector tab group 312A are welded to the first electrode sheet S1 of the electrode assembly 21. The current collector tab group 311A is situated on one side of the winding axis E of the electrode assembly 21 in the first array direction D1, and the current collector tab group 312A is situated on the other side of the winding axis E of the electrode assembly 21 in the first array direction D1.

The current collector tab group 311B and the current collector tab group 312B are welded to the first electrode sheet S1 of the electrode assembly 22. The current collector tab group 311B is situated on one side of the winding axis E of the electrode assembly 22 in the first array direction D1, and the current collector tab group 312B is situated on the other side of the winding axis E of the electrode assembly 22 in the first array direction D1.

The current collector tab group 311A, the current collector tab group 312A, the current collector tab group 311B, and the current collector tab group 312B are laser-welded to the principal face 51M. Specifically, the current collector tab group 311A passes through the through hole 411 and the through hole 511. A distal end portion P1 of the current collector tab group 311A in a direction protruding from the first winding face F1 is bent and welded to the principal face 51M by laser light.

The current collector tab group 312A passes through the through hole 412 (see FIG. 2) and the through hole 512 (see FIG. 2). A distal end portion P2 of the current collector tab group 312A in the direction protruding from the first winding face F1 is bent and welded to the principal face 51M by laser light.

The current collector tab group 311B passes through the through hole 413 (see FIG. 2) and the through hole 513 (see FIG. 2). A distal end portion P3 of the current collector tab group 311B in the direction protruding from the first winding face F1 is bent and welded to the principal face 51M by laser light.

The current collector tab group 312B passes through the through hole 414 (see FIG. 2) and the through hole 514 (see FIG. 2). A distal end portion P4 of the current collector tab group 312B in the direction protruding from the first winding face F1 is bent and welded to the principal face 51M by laser light. Note that the method for welding each of the current collector tab group 311A, the current collector tab group 312A, the current collector tab group 311B, and the current collector tab group 312B to the principal face 51M is not limited to laser welding, and may be vibration welding, for example.

Referring to FIG. 5, the current collector plate 52 includes a principal face 52M situated on the side of the current collector plate 52 opposite to the side on which the insulating member 40 is situated. The current collector tab group 321A and the current collector tab group 322A are welded to the second electrode sheet S2 of the electrode assembly 21. The current collector tab group 321A is situated on one side of the winding axis E of the electrode assembly 21 in the first array direction D1, and the current collector tab group 322A is situated on the other side of the winding axis E of the electrode assembly 21 in the first array direction D1.

The current collector tab group 321B and the current collector tab group 322B are welded to the second electrode sheet S2 of the electrode assembly 22. The current collector tab group 321B is situated on one side of the winding axis E of the electrode assembly 22 in the first array direction D1, and the current collector tab group 322B is situated on the other side of the winding axis E of the electrode assembly 22 in the first array direction D1.

The current collector tab group 321A, the current collector tab group 322A, the current collector tab group 321B, and the current collector tab group 322B are laser-welded to the principal face 52M. Specifically, the current collector tab group 321A passes through the through hole 421 and the through hole 521. A distal end portion Q1 of the current collector tab group 321A in the direction protruding from the first winding face F1 is bent and welded to the principal face 52M by laser light.

The current collector tab group 322A passes through the through hole 422 (see FIG. 2) and the through hole 522 (see FIG. 2). A distal end portion Q2 of the current collector tab group 322A in the direction protruding from the first winding face F1 is bent and welded to the principal face 52M by laser light.

The current collector tab group 321B passes through the through hole 423 (see FIG. 2) and the through hole 523 (see FIG. 2). A distal end portion Q3 of the current collector tab group 321B in the direction protruding from the first winding face F1 is bent and welded to the principal face 52M by laser light.

The current collector tab group 322B passes through the through hole 424 (see FIG. 2) and the through hole 524 (see FIG. 2). A distal end portion Q4 of the current collector tab group 322B in the direction protruding from the first winding face F1 is bent and welded to the principal face 52M by laser light. Note that the method for welding each of the current collector tab group 321A, the current collector tab group 322A, the current collector tab group 321B, and the current collector tab group 322B to the principal face 52M is not limited to laser welding, and may be vibration welding, for example.

In this way, according to the present embodiment, the insulating member 40 is disposed so as to cover the first winding face F1. Thus, according to the present embodiment, when welding the current collector tab group 31 and the current collector plate 51 together, foreign matter produced during welding is suppressed from becoming incorporated into the electrode assembly 20. Note that the method by which the current collector tab group 31 and the current collector plate 51 are be welded together conceivably may be by laser welding, vibration welding, or the like. According to the present embodiment, when the current collector tab group 31 and the current collector plate 51 are laser-welded, foreign matter such as fumes and so forth produced during the laser welding is suppressed from becoming incorporated into the electrode assembly 20. When the current collector tab group 31 and the current collector plate 51 are vibration-welded, fine metallic foreign matter may be produced. However, according to the present embodiment, when the current collector tab group 31 and the current collector plate 51 are vibration-welded, such metallic foreign matter is suppressed from becoming incorporated into the electrode assembly 20. Similarly, according to the present embodiment, when welding the current collector tab group 32 and the current collector plate 52 together, foreign matter produced during welding is suppressed from becoming incorporated into the electrode assembly 20.

Also, according to the present embodiment, the insulating member 40 is disposed so as to cover the first winding face F1, and accordingly the insulating member 40 is situated between the current collector plate 51 and the electrode assembly 20, and between the current collector plate 52 and the electrode assembly 20. Generally, when a current collector plate is disposed close to an electrode assembly, there is a risk that a cathode (cathode sheet) of the electrode assembly may come into contact with an anode current collector plate, or that an anode (anode sheet) of the electrode assembly may come into contact with a cathode current collector plate. However, according to the present embodiment, the insulating member 40 is provided between the current collector plate 51 and the electrode assembly 20, and between the current collector plate 52 and the electrode assembly 20. Thus, according to the present embodiment, contact between the cathode (first electrode sheet S1) of the electrode assembly and the anode current collector plate (current collector plate 52) is suppressed. Also, according to the present embodiment, contact between the anode (second electrode sheet S2) of the electrode assembly and the cathode current collector plate (current collector plate 51) is suppressed.

According to the present embodiment, the current collector tab group 311 (first current collector tab group) and the current collector tab group 312 (second current collector tab group) are disposed spaced apart in the first array direction D1 and the second array direction D2. Also, the current collector tab group 321 (first current collector tab group) and the current collector tab group 322 (second current collector tab group) are disposed spaced apart in the first array direction D1 and the second array direction D2. Thus, according to the present embodiment, the current collector tab group 311A and the current collector tab group 312A are suppressed from overlapping with each other on the principal face 51M. Also, according to the present embodiment, the current collector tab group 311B and the current collector tab group 312B are suppressed from overlapping with each other on the principal face 51M. Also, according to the present embodiment, the current collector tab group 321A and the current collector tab group 322A are suppressed from overlapping with each other on the principal face 52M. Also, according to the present embodiment, the current collector tab group 321B and the current collector tab group 322B are suppressed from overlapping with each other on the principal face 52M. When the current collector tab groups overlap each other on the principal face of the current collector plate, there is a risk of defective welding between the current collector tab group and the current collector plate. However, according to the present embodiment, overlapping of the current collector tab groups each other on the principal face of the current collector plate is suppressed, and accordingly occurrence of defective welding between the current collector tab group and the current collector plate is also suppressed.

As described above, according to the present embodiment, the insulating member 40 is disposed so as to cover the first winding face F1. Accordingly, gas released from the electrode assembly 20 does not readily flow above the insulating member 40 (on the opposite side of the insulating member 40 from the side on which the electrode assembly 20 is situated). However, according to the present embodiment, the smoke discharge valve 13 is provided on the bottom wall 111. Thus, according to the present embodiment, gas released from the electrode assembly 20 is efficiently discharged to the outside of the case 10.

In the present embodiment, the insulating plate 70 is disposed between the electrode assembly 20 and the lid body 121 so as to cover the insulating member 40 and the current collector plates 51, 52. Therefore, according to the present embodiment, short-circuiting of the lid body 121 and the electrode assembly 20 is suppressed.

According to the present embodiment, the insulating plate 70 is disposed between the electrode assembly 20 and the lid body 121 so as to cover the insulating member 40 and the current collector plates 51, 52. Thus, gas released from the electrode assembly 20 does not readily flow above the insulating plate 70 (on the side of the insulating plate 70 opposite to the side on which the electrode assembly 20 is situated). However, according to the present embodiment, the smoke discharge valve 13 is provided on the bottom wall 111. Thus, according to the present embodiment, gas released from the electrode assembly 20 is efficiently discharged to the outside of the case 10.

The embodiment disclosed herein should be considered to be exemplary in all respects and not restrictive. The scope of the present disclosure is defined by the claims rather than by the above description, and is intended to include all modifications within the meaning and scope equivalent to those of the claims.

What is claimed is:

1. A power storage device comprising an electrode assembly in which a laminated sheet including a first electrode sheet, a separator, and a second electrode sheet, is wound about a winding axis, wherein:
the electrode assembly includes
a first winding face and a second winding face that are disposed spaced apart in an axial direction in which the winding axis extends, and
a current collector tab group protruding from the first winding face in the axial direction;
the power storage device further includes
an insulating member disposed so as to cover the first winding face, with a first through hole opened in the insulating member, and
a current collector plate disposed on the insulating member, with a second through hole opened in the current collector plate;
the current collector plate includes a principal face situated on a side of the current collector plate opposite to a side on which the insulating member is situated;
the current collector tab group passes through the first through hole and the second through hole; and
a distal end portion of the current collector tab group in a direction protruding from the first winding face is bent and welded to the principal face.

2. The power storage device according to claim 1, wherein:
the current collector tab group includes a first current collector tab group and a second current collector tab group;
the electrode assembly includes a peripheral face connecting the first winding face and the second winding face;
the peripheral face includes a first flat face, a second flat face, and a first curved face and a second curved face connecting the first flat face and the second flat face;
the first flat face and the second flat face are arrayed in a first array direction;
the first curved face and the second curved face are arrayed in a second array direction intersecting the first array direction; and
the first current collector tab group and the second current collector tab group are disposed spaced apart in the first array direction and the second array direction.

3. The power storage device according to claim 1, further comprising a case that accommodates the electrode assembly, wherein:
the case includes a case body having an opening, and a lid including a lid body that is fashioned to cover the opening;
the case body includes a bottom wall and a peripheral wall erected from the bottom wall; and
the power storage device further includes a smoke discharge valve provided in the bottom wall.

4. The power storage device according to claim 1, further comprising:
a case that accommodates the electrode assembly; and
an insulating plate, wherein:
the case includes a case body having an opening, and a lid including a lid body that is fashioned to cover the opening; and
the insulating plate is disposed between the electrode assembly and the lid body so as to cover the insulating member and the current collector plate.

5. The power storage device according to claim 4, wherein:
the case body includes a bottom wall and a peripheral wall erected from the bottom wall; and
the power storage device further includes a smoke discharge valve provided in the bottom wall.
